(19) United States
(12) Patent Application Publication
(10) Pub. No.: US 2014/0036882 A1
(43) Pub. Date: Feb. 6, 2014

(54) METHOD AND SYSTEM OF HANDLING IN-DEVICE COEXISTENCE IN VARIOUS WIRELESS NETWORK TECHNOLOGIES

(71) Applicants: Sudhir Kumar Baghel, Bangalore (IN); Mangesh Abhimanyu Ingale, Bangalore (IN); Soeng-Hun Kim, Gyeonggi-do (KR)

(72) Inventors: Sudhir Kumar Baghel, Bangalore (IN); Mangesh Abhimanyu Ingale, Bangalore (IN); Soeng-Hun Kim, Gyeonggi-do (KR)

(73) Assignee: Samsung Electronics Co., Ltd., Gyeonggi-do (KR)

(21) Appl. No.: 14/009,319

(22) PCT Filed: Mar. 29, 2012
(86) PCT No.: PCT/KR12/02326

§ 371 Date: Oct. 1, 2013

(30) Foreign Application Priority Data
Apr. 1, 2011 (IN) 1115/CHE/2011

(51) Int. Cl. H04L 5/00

(52) U.S. Cl. CPC H04L 5/0058
USPC 370/336; 370/329

(57) ABSTRACT

A method and system for handling in-device co-existence in wireless network technologies is disclosed. The method provides Time Division Multiplexing and power domain based solutions for in device co-existence. In TDM based approach, the method sends interference indication and assistant information to the Base station. In an embodiment, a preferred solution may also be sent to the Base station. Further, the Base station takes a decision on the preferred solution to be employed. In power domain approach, Base station reduces the transmission power of the LTE uplink transmission which actually overlaps with ISM/GNSS reception opportunity. Further, a hybrid based solution for implementation of TDM and power domain solution based on the scenario is also disclosed. Even though the proposed mechanism is discussed from 3GPP LTE/LTE-Advanced context, it is in general applicable to similar cellular technologies.

### TECHNICAL FIELD

The present invention relates to multiple radio interfaces, and more particularly to handling in device coexistence between distinct wireless network technologies within a mobile device.

### BACKGROUND ART

Wireless communication is omnipresent in today's society as people increasingly use cordless phones, cellular phones, texting devices, wireless data communication devices, and the like on a daily basis. It is pervasive to communicate wirelessly in all types of environments such as residential homes, businesses and so on.

With the increasing availability of wireless technology and connectivity, devices carrying multiple radios are common. The combination of Industrial, Scientific and Medical (ISM), Global Navigation Satellite System (GNSS) and Long Term Evolution (LTE) technologies may be made available on communication platforms such as laptops and handheld devices. Such platforms may be referred to as a Multi-Radio Platforms (MRPs). MRPs may include the co-location of ISM, LTE and even GNSS radios to accommodate various uses and conveniences.

Wireless technologies like LTE, ISM (includes Bluetooth, Wi-Fi) and GNSS (includes GPS, Modernized GPS, GALILEO, GLONASS, Space Based Augmentation Systems (SBAS), Quasi Zenith Satellite System (QZSS) are developed by different groups to serve specific purpose. Characteristics of each of these technologies are different. They operate in different frequency; different access mechanism, different frame structure and peak transmit power. The main causes of in-device co-existence problem issues are receiver blocking which limits the dynamic range and out of band emission due to imperfect filtering. When two radios operate in adjacent band (small separation e.g. <20 MHz) usually 50 dB isolation is required. Small form factor of mobile terminal provides only 10-30 dB isolation. As a result, transmitter of one radio severely affect receiver of another radio. Also, in some cases harmonics generated by LTE (or similar technologies) transmission may cause interference to GNSS receiver.

Currently, various Time Division Multiplex (TDM), Frequency Division Multiplex (FDM), Power Domain or combination solutions are known for handling in device co-existence. TDM solution involves creating LTE ON and OFF periods so that only LTE is active in LTE ON duration. ISM or GNSS receiver gets sufficient interference free time for its operation during LTE OFF periods. There are various types of TDM approaches such as reduced Hybrid Access Repeat Request (HARQ) process based or Discontinuous Reception (DRX) based mechanism. However, GNSS characteristics are such that these mechanisms are not very suitable. Power domain solution involves reducing transmission power of transmitter of one technology such that during simultaneous operation the in-device receiver of the other technology does not get blocked. Even though output power control to solve in-device co-existence issue is known, but the reduced power is blindly applied to all the transmissions and retransmissions performed by the UE. However, a time analysis of LTE transmission opportunity and ISM/GNSS reception opportunity suggest that it is not required to reduce the transmission power all the time.

Also, current methods uses HARQ (Hybrid automatic repeat request) process based TDM solution for LTE and GNSS in-device coexistence. In this method, some of the HARQ processes are reserved for LTE operation whereas some of the LTE HARQ processes are not used so that GNSS can work in those time gaps. If reduced number of HARQ processes is used as TDM solution to provide sufficient time for GNSS operation then similar to DRX based mechanism unnecessarily restriction is put on Enhanced Node B (eNB) scheduler. Since LTE UL HARQ is synchronous it means that reduced HARQ process mechanism exactly specifies where the UL transmission can be present and where it cannot be present. The reservation of HARQ process is not at all needed by the GNSS receiver for its operation because it has a much relaxed time scale of 20 ms per bit. This shows that reduced HARQ process based or DRX based TDM solution may work for LTE and GNSS coexistence but unnecessary restriction is put on eNB scheduler increasing its complexity further and unnecessary incurring signaling overhead.

### DISCLOSURE OF INVENTION

### Technical Problem

Due to the above mentioned reasons it is evident that existing solutions are not effective in handling in device co-existence scenarios. As a result, there is a need for an effective mechanism that ensures the load on the eNodeB is reduced.

### Solution to Problem

The principal object of the embodiments herein is to address in-device co-existence interference in user equipment device.

Another object of the invention is to provide a Time Division Multiplexing solution for handling co-existence problem between LTE, GNSS and ISM band frequencies in user equipment device.

Another object of the invention is to provide a Power Domain solution for handling co-existence problem between LTE, GNSS and ISM band frequencies in user equipment device.

Another object of the invention is to provide a Hybrid solution employing the combination of TDM and Power Domain solution for handling co-existence problem between LTE, GNSS and ISM band frequencies in user equipment device.

Accordingly the invention provides a method for eliminating interference due to co-existence of multiple radio technologies in user equipment in a communication network. The method comprising determining by the user equipment (UE) whether there is interference experienced in global navigation satellite system (GNSS) receiver due to long term evolution (LTE) activity on the UE, sending an indication of the interference and assistant information by the user equipment to a base station, and restricting LTE uplink (UL) allocation per GNSS bit time window below a threshold by the base station based on the assistant information.

Accordingly the invention provides a user equipment (UE) for eliminating interference due to co-existence of multiple radio technologies in the user equipment in a communication network. The UE configured for determining whether there is interference experienced in global navigation satellite system (GNSS) receiver due to long term evolution (LTE) UL allocation to the UE, sending an indication of the interference and assistant information by the user equipment to a base station, and restricting LTE uplink (UL) allocation below a new threshold by the base station based on the assistant information.

Accordingly the invention provides a method for eliminating interference due to co-existence of multiple radio technologies in user equipment in a communication network. The method comprising determining by the user equipment (UE) whether there is interference experienced in global navigation satellite system (GNSS) receiver due to long term evolution (LTE) UL allocation to the UE, obtaining preferred options for controlling the interference caused due to the LTE UL allocation to the UE, sending an indication of the interference and assistant information by the user equipment to a base station, sending preferred options to the base station for controlling the interference caused due to the LTE allocation to the UE, and restricting LTE uplink (UL) allocation by the base station based on the assistant information.

Accordingly the invention provides a user equipment (UE) for eliminating interference due to co-existence of multiple radio technologies in the user equipment in a communication network. The UE configured for determining whether there is interference experienced in global navigation satellite system (GNSS) receiver due to long term evolution (LTE) UL allocation to the UE, obtaining preferred options for controlling the interference caused due to the LTE UL allocation to the UE, sending an indication of the interference and assistant information by the user equipment to a base station, sending preferred options to the base station for controlling the interference caused due to the LTE allocation by the UE, and restricting LTE uplink (UL) allocation below a new threshold by the base station based on the assistant information.

Accordingly the invention provides a method for co-existence of long term evolution (LTE) and industrial, scientific and medical (ISM) radio in user equipment (UE). The method comprising sending information on offset derived from a synchronization point and LTE frame timing by the UE to a base station, deriving HARQ reservation process (pattern) based on the offset derived from the synchronization point and the LTE frame timing by the UE, and sending the HARQ reservation bitmap pattern based on the offset between LTE and Bluetooth by the UE to the base station.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a general block diagram showing the communication between the base station and multiple user equipment, according to embodiments as disclosed herein;

FIG. 2 is a block diagram showing several modules present in the user equipment, according to embodiments as disclosed herein;

FIG. 3 is a flow diagram illustrating an exemplary method of providing sufficient interference free per GNSS bit time, according to one embodiment as disclosed herein;

FIG. 4 is a flow diagram illustrating an exemplary method of providing sufficient interference free per GNSS bit time, according to another embodiment as disclosed herein;

FIG. 5 is a flow diagram illustrating an exemplary UE preferred option based method of handling coexistence between GNSS and LTE, according to one embodiment as disclosed herein;

FIG. 6 is a flow diagram illustrating an exemplary UE preferred option based method of handling coexistence between GNSS and LTE, according to another embodiment as disclosed herein;

FIG. 7 is a frame format showing application of solution ON/OFF pattern during GNSS sub frame length, according to one embodiment as disclosed herein;

FIG. 8 is a frame format showing application of solution ON/OFF pattern during GNSS sub frame length, according to another embodiment as disclosed herein;

FIG. 9 is a schematic representation illustrating interference caused by LTE UL transmission to ISM reception for TDD or for FDD system, according to embodiments as disclosed herein;

FIG. 10 is a flow diagram of an exemplary method of uplink transmission power control, according to embodiments as disclosed herein;

FIG. 11 is a schematic representation illustrating UE transmission power control solution, according to embodiment as disclosed herein;

FIGS. 12A and 12B are a flow diagram of an exemplary method for enabling an Adaptive co-existence solution, according to embodiment as disclosed herein; and

FIGS. 13A and 13B are a flow diagram of an exemplary method of enabling a change from power domain solution to TDM solution, according to embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a system and method for in-device coexistence problem faced by GNSS receiver located in a user equipment due to closely located LTE (or similar technologies) uplink transmission. The uplink transmission by cellular technology such as LTE causes interference to GNSS receiver. The user equipment (UE) is enabled with multi-radio platforms. In one embodiment user equipment may be a mobile station, mobile device, tablet, personal digital assistant, smart phone and the like. The user equipment includes LTE, GNSS and ISM technologies that communicate with the base station to provide the necessary services to the user. In an embodiment, the base station may be referred as E-UTRAN Node B, Evolved Node B (abbreviated as eNodeB or eNB). In another embodiment, the eNode B may be referred to as Base station interchangeably.

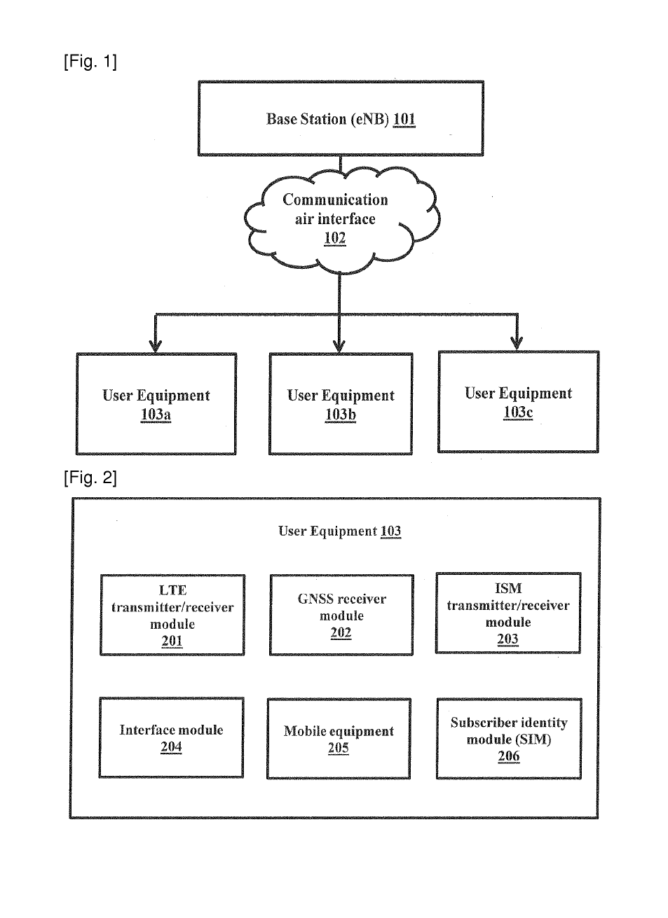

Referring now to the drawings, and more particularly to FIGS. 1 through 13, where similar reference characters denote corresponding features consistently throughout the figures, there are shown preferred embodiments.

FIG. 1 is a general block diagram showing the communication between the base station and multiple user equipment, according to embodiments as disclosed herein. As depicted in the figure the base station and the user equipment device communicate wirelessly. The base station 101 is connected through the communication air interface 102 to the UE. The user equipment 103a, 103b and 103c are also connected with the communication air interface 102 in order to wirelessly communicate with the base station. The communication air interface 102 is based on cellular technology like 3GPP LTE and its evolution LTE-Advanced. The communication air interface 102 may be based on other cellular technologies like WiMAX, CDMA and so on. The base station sends and receives communication signals from the user equipment devices. There may be any number of user equipment devices communicating with the base station.

FIG. 2 is a block diagram showing several modules present in the user equipment, according to embodiments as disclosed herein. As depicted in the figure, the user equipment 103 comprises several modules in itself and capable of communicating with the base station 101. The user equipment 103 is built in with multi-radio such as LTE, GNSS and ISM. The LTE transmitter/receiver module 201 in the user equipment transmits and receives LTE signals to and from the base station 101. The GNSS receiver module 202 receives the GNSS signals from the satellite. The GNSS referred throughout the invention is a collective term given for GPS, GALLILEO, GLONASS and so on. In one embodiment, the LTE and the GNSS receiver module may be integrated in the user equipment 103. In another embodiment the LTE and GNSS receiver module are individual modules in the user equipment 103.

The ISM transmitter/receiver module 203 transmits and receives the signals to and from other remote ISM device like WiFi access point or Bluetooth head set. The industrial, scientific and medical (ISM) radio bands are radio bands which are portions of the radio spectrum reserved internationally for the use of radio frequency (RF) energy for industrial, scientific and medical purposes other than communications in 2.4 GHz band. In one embodiment, the ISM may be referred to Bluetooth, Wi-Fi and the like. In one embodiment, the user equipment device 103 is connected with the Bluetooth headset and continuously transmits and receives signals from the Bluetooth headset during an audio call.

The Interface module 204 provides the interface between the above mentioned modules such as LTE, GNSS and ISM. The interface module 204 allows the user equipment to communicate with the respective air interface.

The Mobile equipment 205 consists of the unique identification number given to every single mobile phone. The unique numbers of user equipment devices within the cellular network are stored in a database containing all valid user equipment.

The subscriber identity module (SIM) 206 is a removable subscriber identification token storing the IMSI (International Mobile Subscriber Identity) a unique key shared with the mobile network operator and other data.

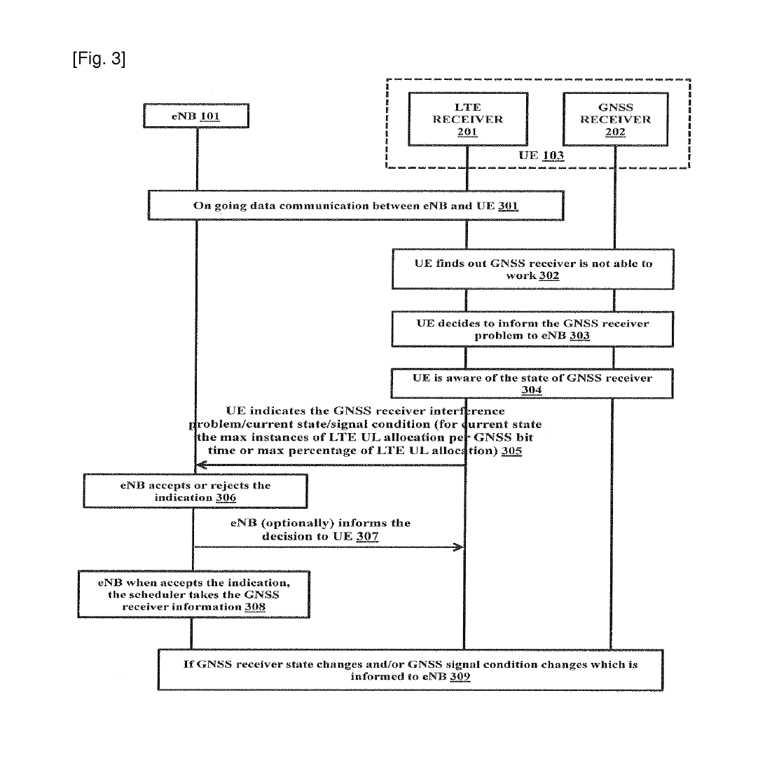

FIG. 3 is a flow diagram illustrating an exemplary method of providing sufficient interference free per GNSS bit time, according to one embodiment as disclosed herein. As depicted in the figure, the base station (eNB) 101 communicates with the user equipment 103 that comprise of LTE transmitter/receiver 201 and GNSS receiver 202. The proposed method provides sufficient interference free time per GNSS bit time so that it can recover GNSS signal. There is an ongoing (301) data communication between base station and UE. Then the GNSS receiver in UE is turned ON. For example, the GNSS receiver receives the signals from the satellite system reading the location of the user equipment 103. Then the UE finds out (302) GNSS receiver is not able to work because the LTE uplink activity in time is beyond a threshold causing interference to GNSS receiver. UE 103 is unable to process bits of GNSS signal. In one embodiment, corresponding to LTE transmission GNSS signal will be interfered for exactly same amount of time as LTE transmission time. If sum of interfered time of GNSS per bit (i.e. 20 ms) is less than certain threshold (say 50%) then GNSS receiver may recover the bit due to huge processing gain provided in GNSS transmission. If total interference time per GNSS bit is greater than certain threshold then GNSS receiver will not be able to decode the signal correctly which will make GNSS receiver unable to perform acquisition or tracking correctly. In one embodiment, the above step happens with direct interaction with GNSS receiver. In another embodiment, the above step happens without direct interaction with GNSS receiver. Then UE decides (303) to inform GNSS receiver interference problem to base station 101. UE determines (304) assistant information that includes the state of GNSS receiver (i.e. acquisition state, tracking state and soon) and/or GNSS signal condition and the like. UE may acquire this information from direct interaction with GNSS receiver. In one embodiment, UE acquires this information by other application software installed in the user equipment. In another embodiment, UE acquires the information based on UE judgment.

Further, UE indicates (305) to the base station that GNSS receiver is suffering from interference because LTE uplink activity in time is beyond certain threshold and/or additionally sends assistant information (current GNSS receiver state and/or GNSS signal condition). In one embodiment, UE informs for the current state the maximum instances of LTE UL allocation per GNSS bit time or maximum percentage of LTE UL allocation (i.e. uplink scheduling restriction threshold). In another embodiment, the UE indicates to base station the GNSS flavor i.e. GPS or GALILEO or GLONASS and the like. The UE may additionally inform the time duration of GNSS signal bit period depending on the flavor of the GNSS system. Then the base station may either accept or rejects (306) the problem indication request from UE. In one embodiment, base station may optionally inform (307) the decision (accept/reject) to the UE.

When the base station accepts (308) the request, the base station scheduler takes the information provided by UE into account and adjusts (restricts) the LTE UL allocation to a certain threshold provided by UE which may be corresponding to current GNSS state and GNSS signal condition so that GNSS receiver will have sufficient time to correctly receive each bit.

In the mean time, ff the GNSS receiver state changes (309) because it was able to successfully decode the signal or it could not decode the signal and moves to any other state and/or signal condition of GNSS changes which requires to be informed to the base station so that base station scheduler may take into account LTE UL allocation. The various actions in method 300 may be performed in the order presented, in a different order or simultaneously. Further, in some embodiments, some actions listed in FIG. 3 may be omitted.

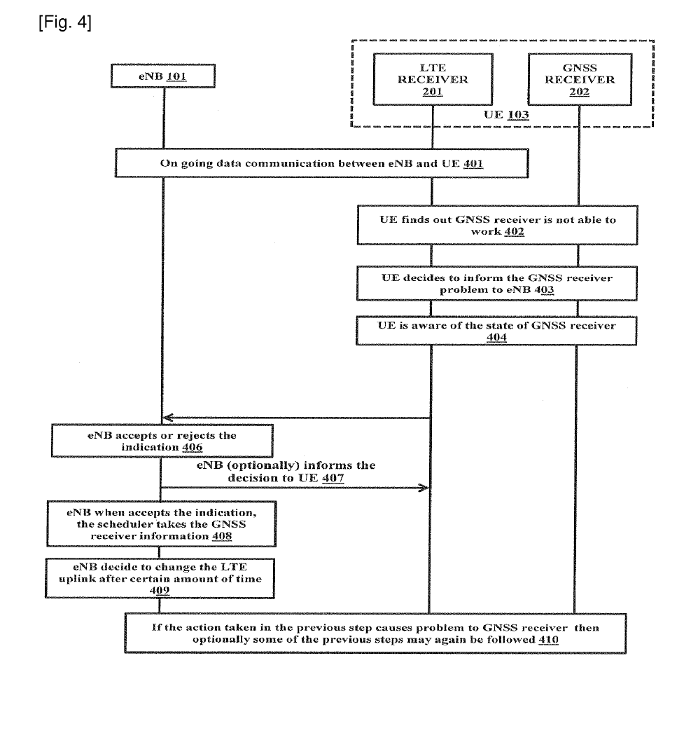

FIG. 4 is a flow diagram illustrating an exemplary method of providing sufficient interference free per GNSS bit time, according to another embodiment as disclosed herein. As depicted in the figure, the base station (eNB) 101 communicates with the user equipment 103 that comprise of LTE receiver 201 and GNSS receiver 202. In one embodiment, the LTE and the GNSS receiver 202 module may be interconnected in the user equipment 103. In another embodiment the LTE 201 and GNSS receiver 202 module are separate modules in the user equipment 103. The proposed method provides sufficient interference free time per GNSS bit time so that it can recover GNSS signal. There is an ongoing (401) data communication between base station 101 and UE 103. Then the GNSS receiver in UE is turned ON. For example, the GNSS receiver receives the signals from the satellite system reading the location of the user equipment 103. Then the UE finds out (402) that GNSS receiver is not able to work because the LTE uplink activity in time is beyond a threshold causing interference to GNSS receiver. The receiver is unable to process bits of GNSS signal. In one embodiment, corresponding to LTE transmission GNSS signal will be interfered for exactly same amount of time as LTE transmission time. If sum of interfered time of GNSS per bit (i.e. 20 ms) is less than certain threshold (say 50%) then GNSS receiver 202 may recover the bit due to huge processing gain provided in GNSS transmission. If total interference time per GNSS bit is greater than certain threshold then GNSS receiver 202 will not be able to decode the signal correctly which will make GNSS receiver 202 unable to perform acquisition or tracking correctly. In one embodiment, the above step happens with direct interaction with GNSS receiver 202. In another embodiment, the above step happens without direct interaction with GNSS receiver 202. Then UE 103 decides (403) to inform GNSS receiver interference problem to base station 101. UE 103 determines (404) the assistant information which includes the state of GNSS receiver 202 (i.e. acquisition state, tracking state and soon) and/or GNSS signal condition. UE may acquire this information from direct interaction with GNSS receiver 202. In one embodiment, UE 103 acquires this information by other application software installed in the user equipment. In another embodiment, UE acquires the information based on UE judgment.

Further, UE 103 indicates (405) to the base station 101 that GNSS receiver 202 is suffering from interference because LTE uplink activity in time is beyond certain threshold and/or additionally informs current GNSS receiver 202 state for a certain period of time and/or GNSS signal condition for a certain period of time. For example, the UE 103 informs the base station 101 that the GNSS receiver 202 is currently in the acquisition state and it will remain in the acquisition state for a certain period of time. UE 103 indicates the validity of the acquisition state in the GNSS receiver 202 to the base station 101. In one embodiment, UE 103 informs to the base station 101 for the current state the maximum instances of LTE UL allocation per GNSS bit time or maximum percentage of LTE UL allocation for a certain period of time (i.e. uplink scheduling restriction threshold).

The base station 101 may either accept or rejects (406) the problem indication from UE. In one embodiment, base station 101 may optionally inform (407) the decision (accept/reject) to the UE 103. When the base station 101 accepts (408) the GNSS problem indication, the base station scheduler takes the information provided by UE 103 into account and adjust (restrict) the LTE UL allocation to a certain threshold provided by UE which may be corresponding to current GNSS state and GNSS signal condition so that GNSS receiver will have sufficient time to correctly receive each bit.

The base station 101 then checks (409) if a pre-defined amount of time has elapsed i.e. the time period provided by the UE and/or base station derives this time period on its own based on GNSS state. The base station 101 may decide to change (restrict) the LTE uplink allocation to some other threshold value. In one embodiment, base station 101 assumes that scheduling restriction applied by it in previous step might have helped GNSS receiver 202 to successfully decode the signal and GNSS receiver 202 could have moved from current state to other state during the time period provided by the UE. The base station checks (410) to determine if there are any changes in the state of the GNSS receiver operation and/or GNSS signal condition and if yes, then the steps 404 to 408 may be performed. The various actions in method 400 may be performed in the order presented, in a different order or simultaneously. Further, in some embodiments, some actions listed in FIG. 4 may be omitted.

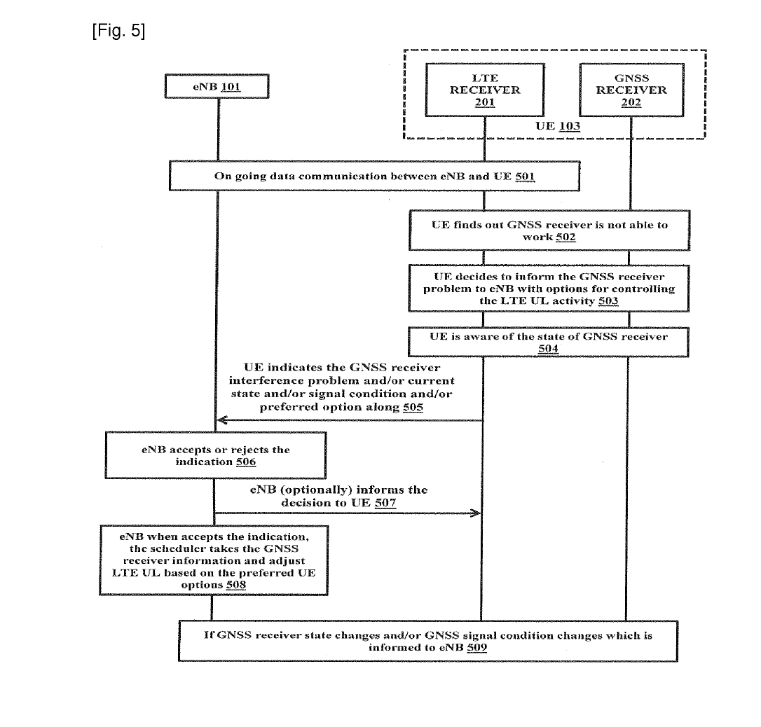

FIG. 5 is a flow diagram illustrating an exemplary UE preferred option based method of handling coexistence between GNSS and LTE, according to one embodiment as disclosed herein. As depicted in the figure, the base station (eNB) 101 communicates with the user equipment 103 that comprise of LTE receiver 201 and GNSS receiver 202. In one embodiment, the LTE 201 and the GNSS receiver 202 module may be interconnected in the user equipment 103. In another embodiment the LTE 201 and GNSS receiver 202 modules are separate modules in the user equipment 103. The proposed method provides sufficient interference free time per GNSS bit time so that it can recover GNSS signal. There is an ongoing (501) data communication between base station 101 and UE 103. Then the GNSS receiver 202 in UE is turned ON. For example, the GNSS receiver 202 receives the signals from the satellite system reading the location of the user equipment 103. Then the UE 103 finds out (502) GNSS receiver 202 is not able to work because the LTE uplink activity in time is beyond a threshold causing interference to GNSS receiver 202. The receiver is unable to process bits of GNSS signal. In one embodiment, corresponding to LTE transmission, the GNSS signal will be interfered for exactly same amount of time as LTE transmission time. If sum of interfered time of GNSS per bit (i.e. 20 ms) is less than certain threshold (say 50%) then GNSS receiver 202 may recover the bit due to huge processing gain provided in GNSS transmission. If total interference time per GNSS bit is greater than certain threshold then GNSS receiver 202 will not be able to decode the signal correctly which will make GNSS receiver 202 unable to perform acquisition or tracking correctly. In one embodiment, the above step happens with direct interaction with GNSS receiver 202. In another embodiment, the above step happens without direct interaction with GNSS receiver 202. Then UE 103 decides (503) to inform GNSS receiver 202 interference problem to the base station 101. In addition, the UE 103 may also choose to provide the possible solutions it would prefer to the base station 101. Depending on UE 103 implementation some options are possible for controlling LTE UL activity such as

a) reduced number of HARQ process (HARQ process reservation)

b) eNB scheduler reduce LTE UL allocations to a certain threshold based on UE indication and

c) DRX based mechanism

The options are given by the UE 103 to control the LTE UL activity. For some GNSS receiver 202 implementation option (a) may be preferable where as for other implementation any of the options is fine. UE 103 finds out (504) the assistant information such as the state of GNSS receiver (i.e. acquisition state, tracking state and soon) and/or GNSS signal condition. UE may acquire this information from direct interaction with GNSS receiver 202. In one embodiment, UE 103 acquires this information by other application software installed in the user equipment 103. In another embodiment, UE 103 acquires the information based on UE judgment. Further, UE 103 indicates (505) to the base station 101 that GNSS receiver 202 is suffering from interference because LTE uplink activity in time is beyond certain threshold and/or additionally informs current GNSS receiver state and/or GNSS signal condition and/or preferred option for controlling (restricting) LTE UL allocation. For example, UE 103 may indicate the preferred option to control the LTE uplink activity is reduced number of HARQ process to the base station 101. In one embodiment of the UE 103 preferred option based method, UE informs for the current state the maximum instances of LTE UL allocation per GNSS bit time or maximum percentage of LTE UL allocation. Alternatively, UE 103 may indicate the preferred option to control the LTE uplink activity is based on DRX.

The base station 101 may either accept or rejects (506) the problem indication from UE 103. In one embodiment, base station 101 may optionally inform (507) the decision (accept/reject) to the UE 103. When the base station 101 accepts (508) the GNSS problem indication, the base station scheduler takes the information provided by UE into account and adjust the LTE UL allocation based on the preferred option indicated by the UE 103. If the GNSS receiver 202 state changes (509) because it was able to successfully decode the signal or it could not decode the signal and moves to any other state and/or signal condition of GNSS changes which requires to be informed to the base station so that base station scheduler may take into account LTE UL allocation. Some of the above mentioned steps are followed to achieve desired result. The various actions in method 500 may be performed in the order presented, in a different order or simultaneously. Further, in some embodiments, some actions listed in FIG. 5 may be omitted.

FIG. 6 is a flow diagram illustrating an exemplary UE preferred option based method of handling coexistence between GNSS and LTE, according to another embodiment as disclosed herein. As depicted in the figure, the base station (eNB) 101 communicates with the user equipment 103 that comprise of LTE receiver 201 and GNSS receiver 202. In one embodiment, the LTE 201 and the GNSS receiver 202 module may be interconnected in the user equipment 103. In another embodiment the LTE 201 and GNSS receiver 202 modules are separate modules in the user equipment 103. The proposed method provides sufficient interference free time per GNSS bit time so that it can recover GNSS signal. There is an ongoing (601) data communication between base station 101 and UE 103. Then the GNSS receiver 202 in UE 103 is turned ON. For example, the GNSS receiver 202 receives the signals from the satellite system reading the location of the user equipment 103. Then the UE 103 finds out (602) GNSS receiver 202 is not able to work because the LTE uplink activity in time is beyond a threshold causing interference to GNSS receiver. The GNSS receiver 202 is unable to process bits of GNSS signal. In one embodiment, corresponding to LTE transmission GNSS signal will be interfered for exactly same amount of time as LTE transmission time. If sum of interfered time of GNSS per bit (i.e. 20 ms) is less than certain threshold (say 50%) then GNSS receiver 202 may recover the bit due to huge processing gain provided in GNSS transmission. If total interference time per GNSS bit is greater than certain threshold then GNSS receiver 202 will not be able to decode the signal correctly which will make GNSS receiver 202 unable to perform acquisition or tracking correctly. In one embodiment, the above step happens with direct interaction with GNSS receiver 202. In another embodiment, the above step happens without direct interaction with GNSS receiver 202. Then UE 103 decides (603) to inform GNSS receiver 202 interference problem to the base station 101. In addition, the UE 103 may also send the preferred solution for the problem to the base station 101. Depending on UE implementation some options are possible for controlling LTE UL activity such as:

a) reduced number of HARQ process (HARQ process reservation);

b) eNB scheduler reduce LTE UL allocations to a certain threshold based on UE indication; and

c) DRX based mechanism.

The options are given by the UE 103 to control the LTE UL activity. For some GNSS receiver 202 implementation option (a) may be preferable where as for other implementation any of the options is fine. The UE 103 determines (604) assistant information that comprises of the state of GNSS receiver (i.e. acquisition state, tracking state and soon) and/or GNSS signal condition. The UE 103 may acquire this information from direct interaction with GNSS receiver 202. In one embodiment, UE 103 acquires this information by other application software installed in the user equipment. In another embodiment, UE 103 acquires the information based on UE judgment.

UE indicates (605) to the base station 101 that GNSS receiver 202 is suffering from interference because LTE uplink activity in time is beyond certain threshold and/or additionally informs current GNSS receiver 202 state for a certain period of time and/or GNSS signal condition for a certain period of time and/or preferred option for controlling LTE UL allocation. For example, UE 103 may indicate the preferred option to control the LTE uplink activity is DRX based mechanism to the base station 101. In one embodiment of the UE 103 preferred option based method UE informs to the base station for the current state the maximum instances of LTE UL allocation per GNSS bit time or maximum percentage of LTE UL allocation for a certain period of time. The base station 101 may either accept or rejects (606) the problem indication from UE 103. In one embodiment, base station 103 may optionally inform (607) the decision (accept/reject) to the UE 101. When the base station accepts (608) the GNSS problem indication, the base station scheduler takes the information provided by UE into account and adjust the LTE UL allocation based on the preferred option indicated by the UE.

The base station 101 then checks (609) when certain amount of time elapsed i.e. the time period provided by the UE and/or base station derives this time period on its own based on GNSS state. The base station 101 may decide to change the LTE uplink allocation to some other threshold value. In one embodiment, base station 101 assumes that scheduling restriction applied by it in previous step might have helped GNSS receiver 202 to successfully decode the signal and GNSS receiver 202 could have moved from current state to other state during the time period provided by the UE 103. The base station checks (610) to determine if there are any changes in the state of the GNSS receiver operation and/or GNSS signal condition and if yes, then the steps 604 to 608 may be performed. The various actions in method 600 may be performed in the order presented, in a different order or simultaneously. Further, in some embodiments, some actions listed in FIG. 6 may be omitted.

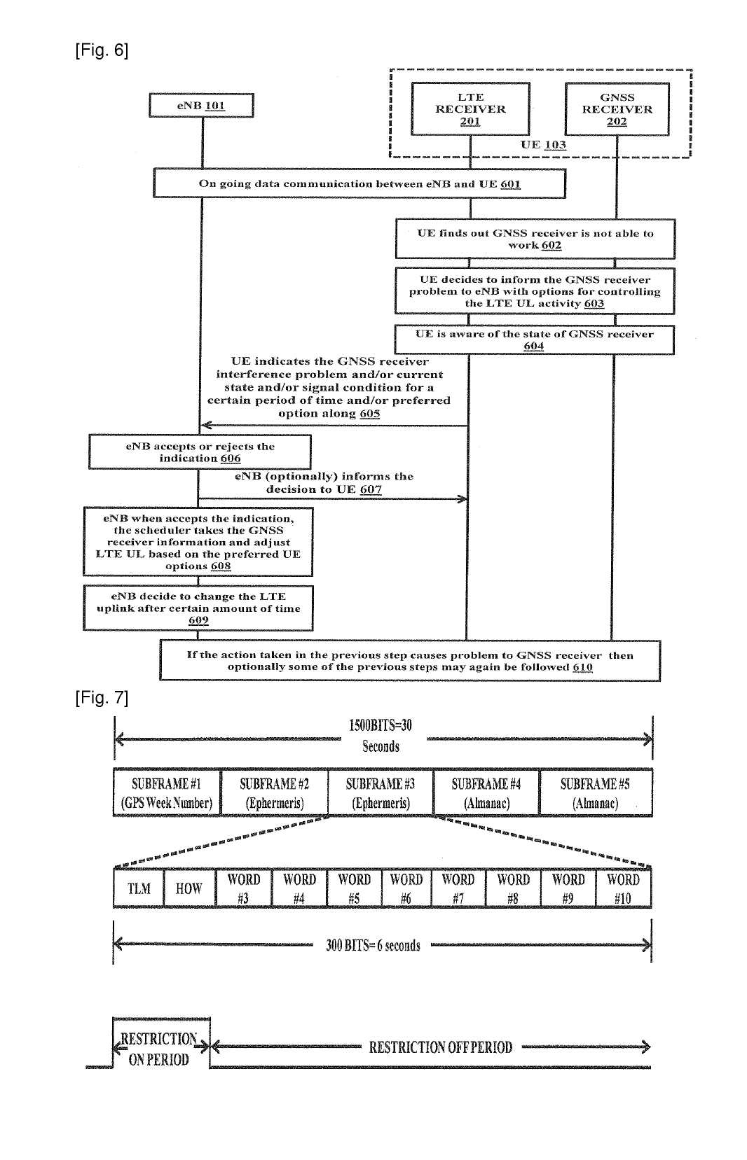

FIG. 7 is a frame format showing application of solution ON/OFF pattern during GNSS sub frame length, according to one embodiment as disclosed herein. The figure depicts a frame format showing application of solution ON/OFF pattern during GNSS sub frame length, according to one embodiment. In steady state operation, GNSS receiver doesn't have to decode certain portion of navigation data such as ephemeris, almanac and so on from the GNSS sub frame. The receiver has to decode some timing signal like the Telemetry (TLM) word and Handover word (HOW) from each sub frame. For the TLM and HOW word of each sub frame of GNSS, it is possible to apply ON and OFF restriction pattern as shown in figure; where during ON time, GNSS receiver 202 needs some guaranteed interference free time every bit length time. This means during the restriction ON period, only LTE Uplink activity needs to be controlled by any of the methods mentioned above. During restriction OFF period, there is no restriction on LTE uplink activity. If required ON and OFF pattern is informed or known to the base station 101 then base station 101 may control LTE UL activity during restriction ON period and use restriction OFF period to compensate for loss of throughput. The various actions in method 700 may be performed in the order presented, in a different order or simultaneously. Further, in some embodiments, some actions listed in FIG. 7 may be omitted.

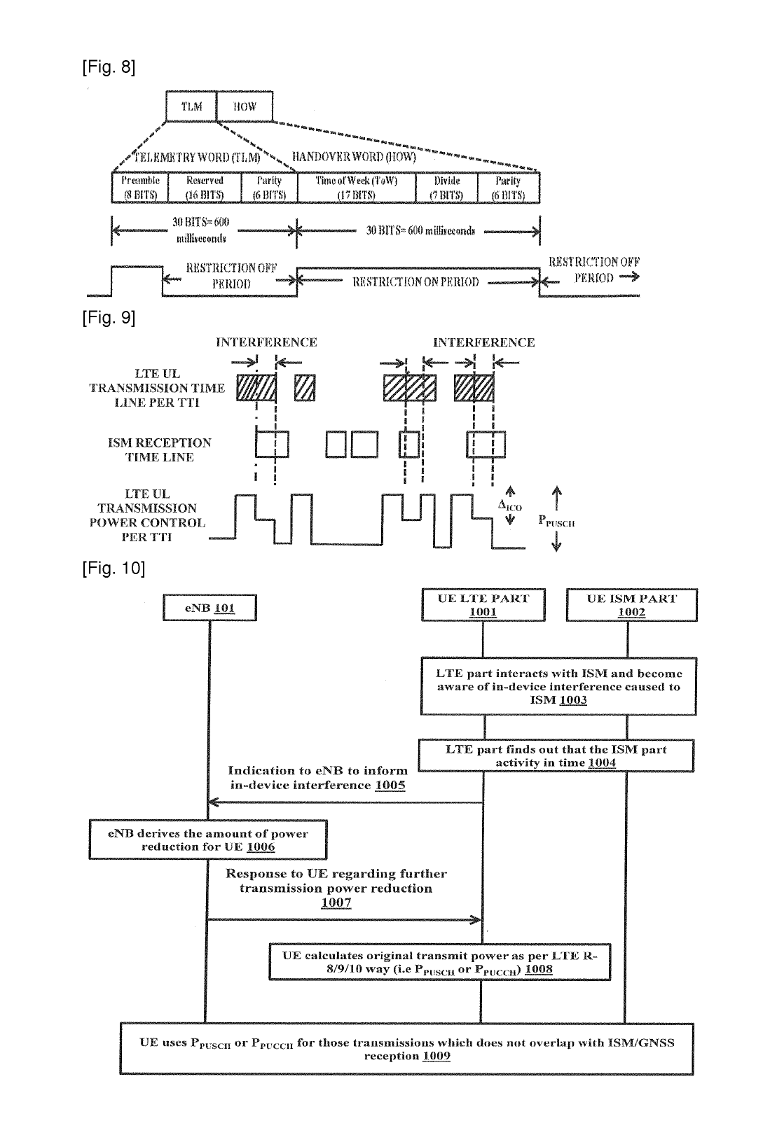

FIG. 8 is a frame format showing application of solution ON/OFF pattern during GNSS sub frame length, according to another embodiment as disclosed herein. The figure depicts a frame format showing application of solution ON/OFF pattern during GNSS sub frame length, according to another embodiment. It can be seen from figure that restriction ON period is valid for only meaningful information of TLM and HOW word while for rest of the GNSS sub frame there is no restriction. In one embodiment, the UE 103 can send multiple patterns for reduced HARQ and base station 101 can select one of them and inform the UE 103 which pattern is selected by the base station 101 in response.

In one embodiment, UE 103 informs start and end of restriction ON period through signaling which can be new signaling or can be combined with the signaling mentioned in the previous methods. In another embodiment, the base station 101 may implicitly derive this ON/OFF pattern based on UE 103 reported GNSS receiver 202 state and knowledge of GNSS time line. Based on this knowledge base station 101 autonomously follow the LTE uplink control required ON and OFF pattern.

In one embodiment of the reduced HARQ process the UE 103 may just send the reference point of synchronization of ISM activity (e.g. the eSCO interval window) with LTE frame timing (i.e. offset). Based on this offset, the base station 101 (eNB) can derive the HARQ reservation process and respond to the UE 103 the bitmap pattern. In another embodiment of the reduced HARQ process, UE 103 can send the reference point of synchronization of ISM activity with LTE frame timing (i.e. offset) and the corresponding bitmap pattern which reserves the HARQ process for LTE usage to the base station 101. The base station 101 may accept or reject the UE 103 suggested bitmap pattern for HARQ reservation. The base station 101 may modify the suggested bitmap pattern based on the synchronization point information (offset) provided by the UE 103. For example, the UE 103 may use 5 processes for LTE and 3 processes for ISM activity out of 8 processes.

There might be multiple reference points for synchronization of ISM activity with LTE frame timing (i.e. multiple offsets). The bitmap pattern for reserving the HARQ process for LTE usage depends on which reference point (offset) is used as synchronization point for LTE and ISM coexistence.

In yet another embodiment of the reduced HARQ process method, the base station 101 modifies the suggested bitmap pattern based on another synchronization point (offset). The base station 101 informs the UE 103 the modified synchronization point (offset) and the corresponding modified bitmap pattern. In further embodiment of the reduced HARQ process, the UE 103 can send multiple bitmap patterns for HARQ process reservation and the corresponding synchronization points (offsets). The base station 101 may select one of them and respond back to the UE 103 which bitmap pattern is selected. The base station 101 may further modify the bitmap pattern based on the corresponding synchronization point (offset).

For different LTE TDD configurations there exist some synchronization points (offsets) for which the interference between LTE and BT will be minimum. In yet another embodiment, it can be defined in the LTE specification what are those optimal synchronization points (offsets) for each TDD configuration. Index to those optimal synchronization points can be used to exchange the information regarding synchronization point mentioned above between UE 103 and base station 101.

FIG. 9 is a schematic representation illustrating interference caused by LTE UL transmission to ISM reception for TDD or for FDD system, according to embodiments as disclosed herein. LTE transmit power control is one possible solution to solve in-device coexistence issue. Interference caused by LTE to ISM and GNSS is dependent on LTE transmit power. If transmit power can be reduced, then it reduces the corresponding interference to ISM and GNSS. Transmit power reduction can cause loss of packets in some cases so it should be controlled by the base station 101.

In one embodiment, base station 101 informs the UE that how much reduction in output power is allowed to handle the in-device coexistence. This reduction in transmit power reduction for the purpose of handling of in-device co-existence can be referred to as Δ_{ICO}. There are two possibilities of applying Δ_{ICO}, for limiting the uplink transmits power:

1. It can be applied directly to the actual uplink transmit power (i.e. P_{PUSCH} or P_{PUCCH}); and

a. i.e. P_{PUSCH2}=P_{PUSCH}−Δ_{ICO}

2. It can be applied to Pcmax so that max output power will get limited to new value which is lesser than Pcmax.

a. i.e. Pcmax2=Pcmax−Δ_{ICO}

However, depending on which method is used out of above two mechanism value for Δ_{ICO} can be different. Also, it is disclosed here only for two uplink physical channels of LTE whereas method is applicable for any uplink transmission. According to an embodiment, where power reduction to solve in-device co-existence is used only on that LTE uplink transmission which actually overlaps with ISM reception slot. For example, LTE TDD band 40 and ISM simultaneous activity can be divided in four categories:

Case 1: LTE UL transmission overlaps with ISM transmission

Case 2: LTE DL reception overlaps with ISM reception

Case 3: LTE DL reception overlaps with ISM transmission

Case 4: LTE UL transmission overlaps with ISM reception.

Simultaneous LTE and ISM activity mentioned in Case 1 and Case 2 is not in device coexistence problem. In time domain, for only some portion of the time, LTE UL transmission causes interference to ISM reception for TDD or for FDD system as shown in FIG. 9. When LTE UL transmission doesn't cause any interference to ISM even when ISM is also operating simultaneously i.e., Case 1, then it is preferable to use original output power for transmission. Whereas, when LTE UL transmission causes interference to ISM reception i.e., Case 4, then it is preferable to apply reduced power for transmission as shown in FIG. 9. As depicted in the figure, the original transmit power which would have been used if there is no in device co-existence problem is reduced by Δ_{ICO} in the interference affected regions. The reduction of LTE UL transmission power is possible on per TTI basis.

FIG. 10 is a flow diagram of an exemplary method of uplink transmission power control, according to embodiments as disclosed herein. The figure depicts the method of uplink transmission power control (e.g. for LTE physical uplink channels PUSCH or PUCCH) used for uplink transmission. The base station (eNB) 101 is in communication with the UE LTE part 1001 and UE ISM part 1002. The LTE part 1001 interacts (1003) with the UE ISM part 1002 and determines the in-device interference caused to ISM. Further, it may also find the level of interference caused to ISM. Further, LTE part finds (1004) out the ISM part activity in time that ISM reception is taking place and when ISM transmission is happening. For example, LTE part finds this from Bluetooth eSCO link for voice has certain patterns of operation.

UE indicates (1005) the base station 101 about the in-device interference and also informs the level of interference. Then the base station 101 derives (1006) how much further power reduction can be allowed for the UE 103 to handle in-device interference i.e., Δ_{ICO}. The base station 101 responds (1007) to the UE 103 regarding further transmission power reduction allowed (Δ_{ICO}) apart from MPR (Maximum Power Reduction) and A-MPR (Additional Maximum Power Reduction).

On receiving the information from the base station 101, the UE 101 calculates (1008) original transmit power as per LTE R-8/9/10 way (i.e., P_{PUSCH} or P_{PUCCH}). UE applies Δ_{ICO} to calculate reduced transmit power (P_{PUSCH2}=P_{PUSCH}−Δ_{ICO}) or (P_{PUCCH2}=P_{PUCCH}−Δ_{ICO}). In one embodiment, UE calculates Pcmax and calculates Pcmax2 (Pcmax2=Pcmax−Δ_{ICO}) by applying further allowed power reduction as informed by the base station 101.

Further, UE 103 may employ (1009) P_{PUSCH} or P_{PUSCH} for those transmissions which do not overlap with ISM/GNSS reception. UE uses P_{PUSCH2} or P_{PUCCH2} for those transmissions which overlap ISM/GNSS reception. In one embodiment, UE 103 uses Pcmax for those transmissions which do not overlap with ISM/GNSS reception. The UE 103 uses Pcmax2 for those transmissions which overlap ISM/GNSS reception. The effect of this is that different HARQ process will have different allowed power output as well as within same HARQ process transmission and retransmission can have different allowed power output.

In another embodiment, since LTE part of UE 103 is aware of ISM activity so a pattern of ISM activity can also be informed to the base station 101. Hence, the base station 101 is aware as to when it can expect the UE 103 to use original power for transmission and when it can expect UE 103 to use reduced power for uplink transmission. When ISM activity pattern is known to the base station 101 it can also schedule lower number of resource blocks, lower order modulation and soon in those time instances which are going to overlap with ISM reception so that inherently UE 103 takes lesser power for UL transmission and doesn't cause interference to ISM.

The ISM activity pattern may be mapped to reduced number of HARQ processes (or HARQ reservation) where those processes which can cause interference (or get affected by) ISM will not be used for scheduling UE.

In one embodiment, the above mentioned power control mechanism can work alone as well as it can work with TDM solution, FDM solution or both. In another embodiment, the UE 103 informs it's preference of solution or preferred combination of solution (e.g. Power control and TDM or Power control and FDM etc.) for in-device coexistence to the base station 101 and the base station 101 may respond back to UE as to which solution or combination of solution is accepted by it.

Proposed Hybrid Method for LTE and GNSS Coexistence

In one embodiment, there may not be GNSS reception happening all the time and hence the GNSS receiver may be free during instances when the GNSS reception is not taking place. Hence for some time durations LTE can transmit with original output power and for some other time durations Δ_{ICO} can be applied on top of original output power to reduce the interference to GNSS receiver. In the proposed TDM method of LTE and GNSS coexistence, if GNSS receiver gets some percentage of interference free time for its operation every 20 ms then it can work properly. This is because of huge processing gain provided in GNSS transmission. However, the proposed TDM method works on the assumption that base station 101 (eNB) scheduler can restrict the LTE uplink activity in time below a certain threshold otherwise GNSS receiver 202 will not be able to successfully decode the signal.

A hybrid Uplink power control based mechanism is disclosed when eNB scheduler is unable to restrict LTE uplink activity in time below a certain threshold. In the disclosed hybrid method, the UE will use original power for transmission in some of uplink grants where as in some of the uplink grant it can use reduced uplink power which is based on Δ_{ICO} on top of original transmission power. In this case, the original transmission power means 3GPP LTE release-8/9/10 mechanism of calculating uplink transmission power. The time instances or the HARQ process where UE 103 is allowed to use the reduced uplink power can be always be defined statically or can be dynamically exchanged between UE 103 and base station 101 in the form of pattern during the steps where UE 103 informs base station 101 that GNSS receiver 202 is suffering from LTE transmission.

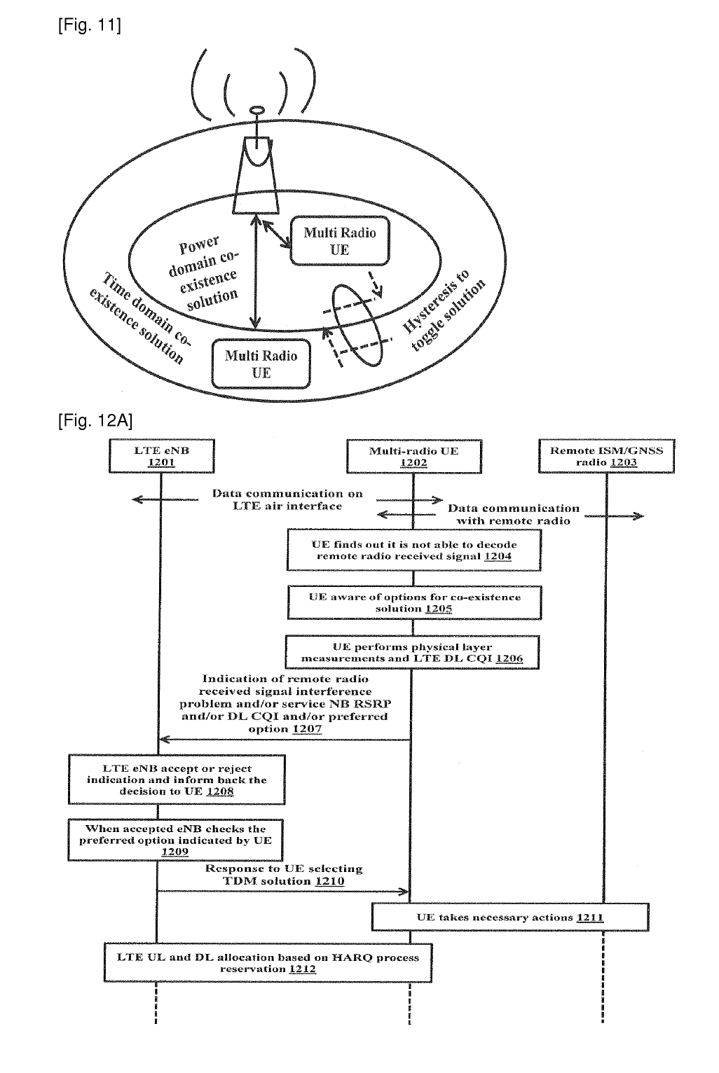

FIG. 11 is a schematic representation illustrating UE transmission power control solution, according to embodiment as disclosed herein. As depicted in the figure LTE and ISM/GNSS co-existence with other co-located radios. The path loss between base station and UE is dependent on the distance between them. When UE is close to the base station 101 the average UE UL transmission power level to compensate the path loss will be less compared to the average UE UL transmission power level when it is far away from the base station 101.

This is valid assuming the same amount of resources and same transport format. Link adaption algorithms implemented in the base station 101 adapts the transport format and average UE UL transmission power so that QoS constraints in terms of data rate and target error rates are satisfied. Further, by controlling the transmission power of UE 103 the interference to adjacent base stations 101 is minimized. Typically UEs far away from base station which are on the cell edge will transmit with most robust transport format and sufficient high transmit power so that base station 101 could decode the received signal to meet the target error rate for achieving the minimum cell edge data rate requirement. Since UE is transmitting with most robust transport format, less amount of UL resources are required to satisfy the minimum cell edge data rate requirement. This fact is exploited to provide TDM based co-existence solution when UE is at cell edge. The TDM solution could be based on reduced HARQ processes or DRX based solution. However, when the UE 103 moves close to the base station 101, link adaptation upgrades the transport format to serve the UE with peak data rate requirement. The transmission power of the UE is controlled such that for the amount of resources allocated to the UE 103, the base station 101 could decode the received signal to meet the target error rate for achieving the peak data rate requirement.

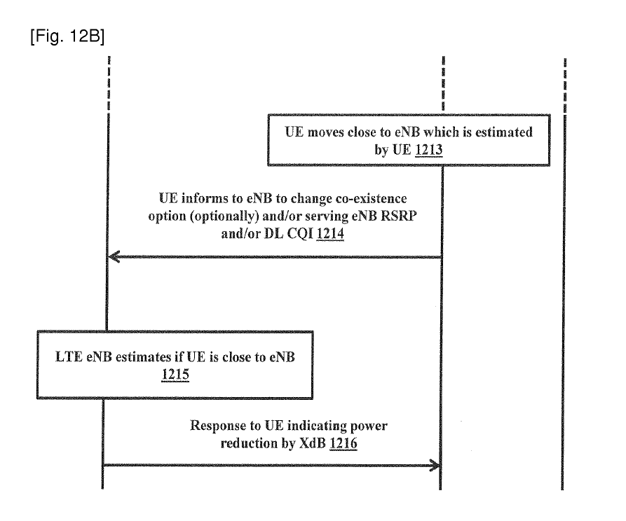

The base station 101 allocates large amount of resources for short intervals promoting highly spectral efficient transport formats. Instead the base station 101 could allocate sufficient resources with high spectral efficient transport format for longer intervals so that transmission power of the UE could be reduced. This fact is exploited to provide UE transmission power control based co-existence solution when UE is close to base station 101. A novel adaptive method to provide co-existence of multiple radios in UE such that TDM solution is enabled when UE 103 is far away from the base station whereas when the UE is close to base station 101, UE transmission power control solution is enabled as shown in FIG. 11. The exact method and procedure to enable the Adaptive co-existence solution is explained in the FIG. 12. The various actions in method 1100 may be performed in the order presented, in a different order or simultaneously. Further, in some embodiments, some actions listed in FIG. 11 may be omitted.

FIGS. 12A and 12B are a flow diagram of an exemplary method for enabling an Adaptive co-existence solution, according to embodiment as disclosed herein. As depicted in the figure, there is a LTE base station (eNB) 1201 and multi radio UE 1202 is simultaneously communicating with base station on LTE air interface and with a remote radio 1203 which could be Wi-Fi access point or remote Bluetooth device or satellite signal from GNSS satellite. The UE finds out (1204) it is not able to decode remote radio received signal because LTE uplink collision with reception from remote radio. UE is aware (1205) of following options for co-existence solution:

a) TDM solution (HARQ process reservation);

b) FDM solution; and

c) LTE UL power control solution.

The UE 103 performs (1206) physical layer measurements (e.g. serving eNB RSRP) and LTE DL CQI. Then UE indicates (1207) to the base station 101 through RRC signaling remote radio received signal interference problem and/or serving eNB RSRP and/or DL CQI and/or preferred option. LTE eNB may accept or reject (1208) indication request and inform back the decision to UE 103. When base station 101 accepts (1209) the indication request, it checks the preferred option indicated by UE and also check the RSRP/DL CQI to estimate whether the UE is close or far away from the base station 101. If base station 101 estimates UE 103 is far away from it then base station 101 prefers TDM solution.

Further, base station through RRC signaling responds (1210) to UE indicating its preference to select TDM solution to provide co-existence for other collocated radios within the UE 103. The selected TDM solution could be either HARQ process reservation based or DRX based solution. The UE 103 takes (1211) necessary action like aligning with LTE frame timing so that data communication with remote radio is interference free at collision instances. LTE eNB scheduler does UL and DL allocation (1212) based on HARQ process reservation (TDM solution) while maintaining QoS constraints. UE moves (1213) close to the base station which is estimated by UE based on improvement in serving eNB RSRP beyond a threshold and DL CQI index is also in the higher range. This is trigger to switch the co-existence solution from TDM based approach to UL power control based approach as motivated above.

In one embodiment of the proposed Adaptive method the UE 103 may inform (1214) optionally to the base station 101 to change co-existence option either through some MAC header control element or RRC signaling and/or report serving eNB RSRP and/or DL CQI. In another embodiment, the base station 101 could estimate if the UE is in close vicinity based on periodically reported DL CQI or based on estimations performed on SRS. LTE eNB estimates (1215) if UE 103 is close to base station and also checks current UE UL power level if it can satisfy QoS constraint. If eNB satisfied with QoSs then calculates reduction in UE power level by X dB. Base station informs (1216) to UE through RRC signaling that when LTE UL activity is not colliding with reception activity of other collocated radio UE has to transmit with actual power whereas in TTIs where UL activity collides with reception activity of other collocated radio UE is allowed to transmit with a power reduction of X dB compared to actual power. The various actions in method 1200 may be performed in the order presented, in a different order or simultaneously. Further, in some embodiments, some actions listed in FIGS. 12A and 12B may be omitted.

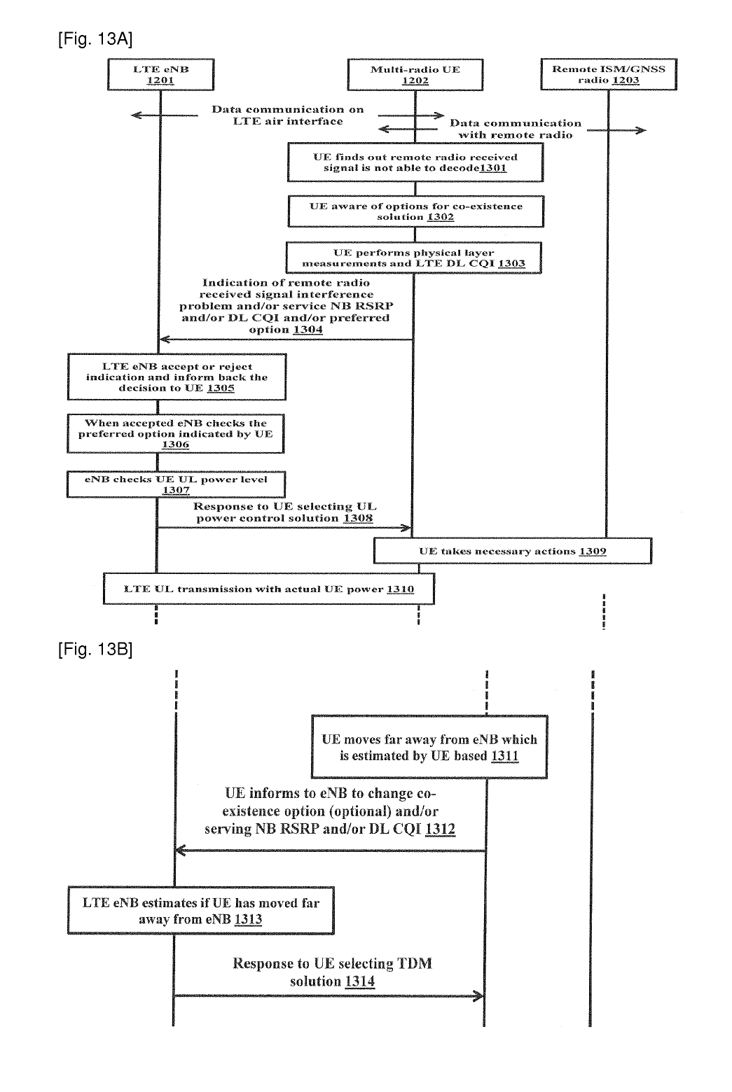

FIGS. 13A and 13B are a flow diagram of an exemplary method of enabling a change from power domain solution to TDM solution, according to embodiment as disclosed herein. As depicted in the figure, there is a LTE base station (eNB) 1201 and multi radio UE 1202 is simultaneously communicating with eNB on LTE air interface and with a remote radio 1203 which could be Wi-Fi access point or remote Bluetooth device or satellite signal from GNSS satellite. UE finds out (1301) it is not able to decode remote radio received signal because LTE uplink collision with reception from remote radio. UE is aware (1302) of following options for co-existence solution:

a) TDM solution (HARQ process reservation);

b) FDM solution; and

c) LTE UL power control solution.

UE performs (1303) physical layer measurements (e.g. serving eNB RSRP) and LTE DL CQI. Then UE 103 sends an indication request (1304) to the base station 101 through RRC signaling remote radio received signal interference problem and/or serving eNB RSRP and/or DL CQI and/or preferred option. LTE eNB may accept or reject (1305) indication request and inform back the decision to UE. When eNB accepts (1306) the UE indication, it checks the preferred option indicated by UE and also check the RSRP/DL CQI to estimate whether the UE is close or far away from eNB. If eNB confirms UE is in close vicinity then it selects the UE power control solution as motivated above. Base station checks (1307) current UE UL power level if it can satisfy QoS constraint. If eNB satisfied with QoS then it calculates reduction in UE power level by X dB. eNB informs (1308) to UE through RRC signaling that when LTE UL activity is not colliding with reception activity of other collocated radio UE has to transmit with actual power whereas in TTIs where UL activity collides with reception activity of other collocated radio UE is allowed to transmit with a power reduction of X dB compared to actual power. UE takes (1309) necessary action as informed by eNB so that data communication with remote radio is interference free. UE transmits (1310) with actual power on LTE air interface where no collision with remote radio reception while in TTI where collision occurs UL transmission power is reduced by X dB. UE moves (1311) far away from eNB which is estimated by UE based on degradation of serving eNB RSRP beyond a threshold and DL CQI index is also in the lower range. This is trigger to switch the co-existence solution from UL power control based approach to TDM based approach as motivated above.

In an embodiment of the proposed Adaptive method UE may inform (1312) optionally to eNB to change co-existence option either through some MAC header control element or RRC signaling and/or report serving eNB RSRP and/or DL CQI. In another embodiment, eNB could estimate if the UE has moved far away towards cell edge based on periodically reported DL CQI or based on estimations performed on SRS. LTE eNB estimates (1313) if UE moved far away towards cell edge it decides to disable UE power control solution. eNB checks current UE UL power level if it can satisfy QoS constraint and enables TDM based solution for co-existence. Then eNB through RRC signaling responds (1314) to UE indicating to disable power control solution and indicates its preference to select TDM solution to provide co-existence for other collocated radios within the UE. The selected TDM solution could be either HARQ process reservation based or DRX based solution. The various actions in method 1300 may be performed in the order presented, in a different order or simultaneously. Further, in some embodiments, some actions listed in FIGS. 13A and 13B may be omitted.

In the current solution there are two Pcmax in case and power control is used as solution to mitigate in-device interference. In one embodiment, it can be fixed that always Pcmax is used for PHR calculation. In another embodiment two PHRs are calculated and reported to eNBs corresponding to Pcmax and Pcmax2. However, since eNB has informed the maximum further reduction i.e. Δ_{ICO} in output power to solve the in-device interference so even if only one PHR (based on Pcmax) is reported eNB can calculate other PHR. In yet another embodiment, Pcmax2 can also be reported along with Pcmax.

In yet another embodiment a new trigger for PHR reporting can be defined which is dependent on in-device co-existence. When UE finds that LTE uplink is causing interference to ISM reception and when power domain solution mentioned above is selected as mechanism to solve the in-device co-existence then PHR can be triggered. Also UE can inform the eNB that this triggered PHR is due to in-device co-existence.

When LTE uplink causes interference to ISM reception then power domain solution can be used as a mechanism where LTE uplink power is reduced to some extent to avoid interference to ISM. However same mechanism can be used to solve Specific Absorption Rate (SAR) related issue. When LTE and ISM transmitter transmit at the same time then the combined radiation may cross the SAR limit defined by different regulatory authorities such as FCC. In this case, UE finds out exactly where ISM is transmitting and if UE thinks that if LTE also transmit at the original power then it might cross the SAR limit. In that case UE will reduce the LTE uplink transmit power using one of the methods mentioned above i.e UE uses original power for uplink transmission when there is no issue of SAR either because ISM uplink transmission power is low or ISM uplink is not overlapping with LTE uplink. UE uses reduced uplink transmission power in LTE when it suspect the combined transmission of LTE and ISM will cross SAR limit. The applicability of power domain solution to solve SAR issue can be used for LTE operation in any band.

In one embodiment, eNB signal UE which Logical channel (LCH) is subject to power reduction mechanism. If there is a need for power reduction for a TTI, and MAC PDU to be transmitted in the TTI contains data only from the LCHs subject to the power control solution, UE reduce the transmission power. The signaling can be done in dedicated manner or broadcast manner to inform UE which LCH is subject to power reduction mechanism. This information can be indicated to UE in response to the indication where UE informs to base station that there exists in-device co-existence.

The embodiments disclosed herein can be implemented through at least one software program running on at least one hardware device and performing network management functions to control the elements. The elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for reducing interference due to co-existence of multiple radio technologies in a user equipment in a communication network, the method comprising:
determining, by the user equipment (UE), whether interference is experienced by a global navigation satellite system (GNSS) receiver due to long term evolution (LTE) activity on the UE;
sending an indication of the interference and assistant information by the user equipment to a base station; and
restricting LTE uplink (UL) allocation per GNSS bit time window below a threshold by the base station based on the assistant information.

2. The method as in claim 1, wherein the determining comprises checking if the GNSS receiver is not able to receive data due to LTE uplink activity in time being beyond a pre-defined threshold causing the GNSS receiver an inability to decode bits correctly.

3. The method as in claim 1, wherein the assistant information includes at least one among: maximum instances of LTE UL allocation per GNSS bit time, a maximum percentage of LTE UL allocation, a tracking state of the GNSS receiver, an acquisition state of the GNSS receiver, a GNSS signal condition, a current GNSS receiver state, GNSS type, time duration of GNSS signal bit period depending on the GNSS type, or an ON and OFF pattern for UL restricted allocation.

4. The method as in claim 1, wherein restricting the LTE UL allocation comprises restricting LTE UL allocation for a data exchange session such that there is sufficient interference free time for receiving each bit on the GNSS receiver.

5. The method as in claim 1, further comprising restricting LTE UL allocation for a pre-defined period of time during a data exchange session, wherein the pre-defined period of time is the GNSS bit time window and is determined by the base station based on current GNSS receiver state and the assistance information related to the pre-defined period of time.

6. The method as in claim 1, further comprising restricting LTE UL allocation for a pre-defined period of time during a data exchange session, wherein the pre-defined period of time is determined by the base station based on an ON and OFF pattern for an UL restricted allocation related to the pre-defined period of time.

7. The method as in claim 1, wherein the multiple radio technologies co-existing include: LTE, GNSS, and industrial, scientific and medical (ISM).

8. (canceled)

9. A user equipment (UE) for reducing interference due to co-existence of multiple radio technologies in the user equipment in a communication network, the UE configured to:
determine whether interference is experienced by a global navigation satellite system (GNSS) receiver due to long term evolution (LTE) UL allocation on the UE; and
send an indication of the interference and assistant information by the user equipment to a base station for restriction of LTE uplink (UL) allocation to below a new threshold by the base station based on the assistant information.

10. A method for reducing interference due to co-existence of multiple radio technologies in a user equipment in a communication network, the method comprising:
determining, by the user equipment (UE), whether there is interference experienced by a global navigation satellite system (GNSS) receiver due to long term evolution (LTE) allocation on the UE;
obtaining, by the UE, preferred options for controlling the interference caused due to the LTE UL allocation;
sending an indication of the interference and assistant information by the user equipment to a base station;
sending, by the UE, the preferred options to the base station for controlling the interference caused due to the LTE allocation; and
restricting LTE uplink (UL) allocation by the base station based on the assistant information.

11. The method as in claim 10, wherein the determining comprising checking by the UE if the GNSS receiver is not able to receive data due to LTE uplink activity in time being beyond a pre-defined threshold causing the GNSS receiver an inability to decode bits.

12. The method as in claim 10, wherein the assistant information includes at least one among: maximum instances of LTE UL allocation per GNSS bit time, a maximum percentage of LTE UL allocation, a tracking state of the GNSS receiver, an acquisition state of the GNSS receiver, a GNSS signal condition, a current GNSS receiver state, GNSS type, time duration of GNSS signal bit period depending on the GNNS type, or an ON and OFF pattern for UL restricted allocation.

13. The method as in claim 10, wherein the preferred options include at least one of: reducing number of HARQ processes, reducing LTE UL allocation below a threshold value based on UE indication, or a discontinuous reception based mechanism.

14. The method as in claim 10, further comprising restricting the LTE UL allocation for a data exchange session below a new threshold such that there sufficient time for receiving each bit on the GNSS receiver.

15. The method as in claim 10, wherein the multiple radio technologies co-existing include: LTE, GNSS, and industrial, scientific and medical (ISM).

16. (canceled)

17. A user equipment (UE) for reducing interference due to co-existence of multiple radio technologies in the user equipment in a communication network, the UE configured to:
determine whether there is interference experienced by a global navigation satellite system (GNSS) receiver due to long term evolution (LTE) UL allocation on the UE;
obtain preferred options for controlling the interference caused due to the LTE UL allocation;
send an indication of the interference and assistant information to a base station;
send preferred options to the base station for controlling the interference caused due to the LTE allocation by the UE for restriction of LTE uplink (UL) allocation below a new threshold by the base station based on the assistant information.

18. The UE as in claim 17, wherein the UE is configured to determine if the GNSS receiver is not able to receive data due to LTE uplink activity in time being beyond a pre-defined threshold causing the GNSS receiver an inability to process bits.

19. The UE as in claim 17, wherein the assistant information includes at least one among: maximum instances of LTE UL allocation per GNSS bit time, a maximum percentage of LTE UL allocation, a tracking state of the GNSS receiver, an acquisition state of the GNSS receiver, a GNSS signal condition, a current GNSS receiver state, GNSS type, time duration of GNSS signal bit period depending on the GNNS type, or an ON and OFF pattern for UL restricted allocation.

20. The UE as in claim 17, wherein the preferred options include at least one of: reducing number of HARQ processes, reducing LTE UL allocation to a new threshold value based on UE indication, or a discontinuous reception based mechanism.

21. The UE as in claim 17, wherein the base station restricts the LTE UL allocation for a data exchange session such that there is sufficient time for receiving each bit on the GNSS receiver.

22. The UE as in claim 17, wherein the base station restricts the LTE UL allocation for a pre-defined period of time, wherein the pre-determined period of time is determined by the base station based on current GNSS receiver state.

23. A method for co-existence of long term evolution (LTE) and industrial, scientific and medical (ISM) radios in a user equipment (UE), the method comprising:
sending information on an offset derived from a synchronization point and LTE frame timing by the UE to a base station;
deriving a HARQ reservation process based on the offset derived from the synchronization point and the LTE frame timing by the UE; and
sending a HARQ reservation bitmap pattern based on the offset and a time offset between LTE and Bluetooth by the UE to the base station.

24. The method as in claim 23, wherein the HARQ reservation process provides a solution for co-existence of the LTE and ISM radio which is Bluetooth without interference.

25. The method as in claim 23, wherein the HARQ reservation bitmap pattern indicates reservation of the HARQ reservation process for LTE usage to the base station.

26. The method as in claim 23, wherein bitmap information is sent to the base station by the UE, and the base station further modifies the bitmap information.
